(19) United States
(12) Patent Application Publication
(10) Pub. No.: US 2008/0276834 A1
(43) Pub. Date: Nov. 13, 2008

(54) BITUMINOUS ROADBUILDING MATERIALS, IN PARTICULAR COLD MIXES AND EMULSION-STABILIZED GRAVEL, AND ROAD PAVEMENTS FORMED FROM THESE MATERIALS

(75) Inventor: Eric Jorda, Lyon (FR)

Correspondence Address: ARKEMA INC.;PATENT DEPARTMENT - 26TH FLOOR, 2000 MARKET STREET, PHILADELPHIA, PA, 19103-3222, US

(73) Assignee: CECA S.A., La Garenne Colombes (FR)

(21) Appl. No.: 12/117,128

(22) Filed: May 8, 2008

(30) Foreign Application Priority Data
May 10, 2007 (FR) 07.54991

(51) Int. Cl. C08L 95/00

(52) U.S. Cl. 106/277

(57) ABSTRACT

Bituminous roadbuilding material obtained by impregnating, coating or contacting an aggregate, a recycling material, a coated aggregate or a mixture of these products with a bituminous emulsion (E), characterized in that the bitumen particles of the bituminous emulsion (E) used for the impregnating, coating or contacting comprise a fraction (F) representing 10 to 40% of the bitumen particles and having a median diameter of less than or equal to 0.6 μm, preferably of between 0.1 μm and 0.6 μm, the remainder of the bitumen particles of the emulsion having a median diameter of greater than or equal to 1 μm, preferably of between 1 and 20 μm. The material is advantageously composed of cold mixes or of emulsion-stabilized gravel.

The present invention relates to a bituminous roadbuilding material obtained by impregnating, coating or contacting an aggregate, a recycling material, a coated aggregate or a mixture of these products with a bituminous emulsion. It also relates to a road pavement advantageously obtained at ambient temperature (that is to say, generally between 0° C. and +40° C.) from this material.

Bituminous emulsions comprise, in the majority of cases, a bituminous binder, a cationic surfactant (the term used is then cationic emulsions) or an anionic surfactant (the term used is then anionic emulsions) and water. Cationic emulsions are particularly valued, both for the speed of their breaking on aggregates and for the adhesion qualities which are generally obtained between the aggregates and the broken emulsion, conferring good mechanical properties on the road pavements which have just been produced. In addition to the components stated above, cationic emulsions are often acidified by addition of acid to the aqueous phase used in the manufacture of the emulsion and anionic emulsions are generally manufactured in an alkaline medium.

The bituminous materials obtained by coating or contacting aggregates using bituminous emulsions have been known for a long time. The profession makes a distinction in particular between poured cold, open-graded, semi-open-graded, dense-graded and storable mixes, emulsion-stabilized gravel, surface coatings and bond coats.

For the production of road pavements, bituminous materials of one type comprise open-graded, semi-open-graded and dense-graded cold mixes, storable cold mixes and emulsion-stabilized gravel. The optimized choice of the emulsion (nature and amount of the emulsifier, concentration of bitumen, pH) makes it possible in the majority of cases to partially or completely solve the problems of coating, transportation and application of the mix in its swollen form. However, once the mix has been spread out in the form of a pavement, the compacting stage is carried out, the role of which is to increase the cohesion, that is to say to ensure good adhesion between bitumen and aggregate, in order to allow the pavement to withstand the traffic, temporarily interrupted during application in the case of repair or rebuilding of roadways. This cohesion is obtained by compacting the material, generally accompanied by the expulsion of aqueous phase and of air. Materials coated cold exhibit a strong frictional property, which interferes with the compacting: the degrees of compactness obtained under cold conditions are very often lower than the degrees of compactness obtained starting from the same materials coated hot with the same binder. In point of fact, it is well known to a person skilled in the art that the value of the degree of compactness and the departure of water on compacting influence the cohesion of the cold-compacted material. Thus, it is found that, at the present time, success in the production of roadways subjected to heavy traffic (T1 or higher) does not depend only on the technology but also on the weather conditions on the day over which the work is carried out and even on the following day. Bright sunshine, a high temperature or a strong enough wind contribute to the drying of the pavement and to its increase in cohesion.

In all the cases of application of cold mixes considered here (storable, open-graded, semi-open-graded, dense-graded and emulsion-stabilized gravel), rapidly (re)opening to traffic causes more problems the heavier the traffic. In the case of premature opening, aggregates are lost at the surface of the coating in contact with the tyres, which weakens the pavement with regard to bad weather and damages its surface quality. This phenomenon is known in the roadbuilding profession, essentially for coatings, under the name of “fretting”, but is also regularly observed on cold mixes used as a surfacing course. It is therefore advantageous to obtain high surface cohesion as rapidly as possible in order to avoid compromising the final overall properties of the pavement.

An improvement in rapid cohesion can be partially contributed by an increase in the efficiency of the compacting by additives, as described in EP 1 057 873 and WO 02/00795, but this improvement is limited and does not affect the surface.

It can also be introduced by addition of a significant amount of cement, as described in WO 02/066394, but the additional cost is then high and the emulsions have to have a very high content of nonionic surfactant, which presents problems of resistance to water subsequently and does not bestow the best stability on the surface at an early age.

Another solution consists in adding breaking agents at various points in the process, as described in WO 94/23129 and in the patent documents cited in the latter. These methods are generally expensive and require modifications to equipment, indeed even novel dedicated equipment, and no mention is made of an improvement in the properties on contact with tyres. Recourse is had, in EP 0 896 985, to a mixture of emulsions of different stability with regard to the aggregates (a “rapid” emulsion and a “slow” emulsion) in order to control the breaking time, whatever the water content of the aggregate, and to facilitate the processing and the compacting, while retaining the ability to develop high cohesion (but cohesion equivalent to that obtained with a standard cold mix, which is sometimes difficult to lay down). The difficulty in finding a compromise between workability and general cohesion of the mix is thus solved here but there is no question whatsoever of improving the surface cohesion.

U.S. Pat. No. 5,518,538 claims the use of emulsions, the diameter of the bitumen globules of which is centred around two different values separated by a factor of 2 to 10. These emulsions, the bitumen content of which is greater than 75%, give an increased rate of coalescence but thus do not make possible the coating of reactive aggregates and are intended solely for spreading applications (“sealing” or coatings). No result of particle size measurements is provided in this United States patent.

WO 96/04427 mentions the difficulty in obtaining good adhesion, before months have passed, between bitumen and aggregates in cold mixes produced with asphaltic bitumen, which prevents cores from being bored in order to analyse the roadways. According to WO 96/04427, the proposal is made to solve this problem by the use of two emulsions with different breaking indices in a two-stage coating process. A first superstabilized emulsion (with a median diameter of between 2 and 8 μm and with a standard deviation of less than 0.3) is used at between 1 and 4% to carry out a first coating. The mix can then be stored for several weeks and a second coating, with 3 to 7% of an emulsion with a lower breaking index than the first, is carried out immediately before application. This process does not mention the use of an emulsion with a submicron diameter and has the disadvantage of repeating the coating stage, which is a costly stage timewise, and provides a solution for the critical mass cohesion for the core boring but does not in any way change the properties of the surface in direct contact with the tyres.

JP 2001 081326 mentions a process for the manufacture of a bituminous emulsion which makes it possible to obtain a discrete particle size distribution comprising two and preferably three peaks, including a peak of less than 1.1 μm. No mention is made in this document of a means for controlling this particle size distribution, which is a priori subject in fact to the equipment used. The median diameter of the smallest particles is, for its part, systematically greater than 0.5 μm and less than 5% of the emulsion appears to exhibit a diameter of less than 0.5 μm. The preferred diameters according to this document for the smallest particles are between 0.9 and 1.6 μm. This document suggests advantages of this emulsion in terms of film formation and drying time but it relates only to applications, such as waterproofing in the building industry, where there is no notion of binder and of adhesion between aggregate particles. The emulsifiers used in the context of this document are furthermore anionic and nonionic emulsifiers, which are less preferred according to the invention as they result in poorer early-age mechanical performances in the roadbuilding field.

EP 1 649 925 describes the manufacture and the use of bituminous emulsions, the particles of which have a median diameter of less than 0.5 μm, for the manufacture of bituminous mixes with an improved early-age cohesion. In this document, no specific mention is made of the surface cohesion but the device used to measure the cohesion is a cohesiometer, which essentially stresses the surface over a thickness of 1 to 2 cm. One disadvantage is that the median diameter of the emulsion is set by the concentration of surfactant of the soap used and that it is thus impossible to adjust the content of emulsifier of the emulsion to the nature of the aggregate to be coated without changing the particle size thereof. This can result, in the event of excess charging, in problems of workability known to a person skilled in the art and makes the technique one which cannot readily be adjusted.

It thus appears that no information from the prior art provides a flexible technical solution which can be adapted to all kinds of aggregates in order to specifically solve the lack of early-age surface cohesion observed with regard to cold mixes for a surfacing course in comparison with hot techniques. This is reflected in practice by a virtually exclusive use of cold mixes for roadways subjected to moderate or low traffic.

The present invention provides cold mixes and emulsion-stabilized gravel, obtained by coating and applied with standard roadbuilding equipment, the early-age surface cohesion (in the first 24 hours) of which is markedly improved (by 50% and more) with respect to the cold mixes and emulsion-stabilized gravel manufactured according to the prior art.

The present invention advantageously differs from the invention described in EP 1 649 925 in that the emulsion used exhibits a stability which can be adjusted to the aggregate without losing the surface cohesion advantages. It is particularly advantageous for roadways subjected to high traffic, insofar as it makes it possible to obtain road pavements having a surface subjected to attack by tyres with a cohesion sufficient to stabilize the structure before reopening to traffic, without it being necessary to wait several days.

The emulsions which are used for the present invention are characterized in that they comprise a well determined percentage of bitumen particles, the diameter of which, measured by laser particle sizing, is less than or equal to 0.6 μm and preferably less than or equal to 0.55 μm, and more preferably less than or equal to 0.5 μm. These emulsions with a specific particle size composition can, for example, be obtained from the emulsion, the particles of which have a median diameter of less than or equal to 0.6 μm (preferably 0.55 μm and more preferably less than or equal to 0.5 μm), by simple mixing with another emulsion, by incorporation of this emulsion in the aqueous phase used to manufacture the final emulsion or by any other method known to a person skilled in the art which makes it possible to quantitatively control the fraction produced of dispersed particles with a diameter of less than 0.6 μm in the final emulsion.

The emulsion, the particles of which have a median diameter of less than or equal to 0.6 μm (preferably less than or equal to 0.55 μm and more preferably less than or equal to 0.5 μm), can be obtained by the process described in EP 1 649 925 or by any other method known to a person skilled in the art. The other bituminous emulsion which is then used for the mixing or the remainder which is manufactured from this emulsion has no distinctive feature apart from a content of surfactant chosen in order to obtain a final emulsion with a stability adapted to the aggregate to be coated.

It is explained, in EP 1 649 925, that it is known to a person skilled in the art that the decrease in the median diameter of an emulsion improves the coating quality of the aggregates but that it had been discovered by us that the cohesion of a mix does not follow this progression as a function of the median diameter of the globules of the emulsion. In the range generally used in the roadbuilding industry, between 2 and 10 μm, and even below, the cohesion remains virtually insensitive to the particle size of the emulsion down to a threshold of 0.6 μm. Below this threshold, the cohesion of the mix suddenly increases.

We have discovered here that this property can be retained even with small proportions of this type of emulsion as a mixture with an emulsion with an uncontrolled particle size. This property can be taken advantage of in the present invention in order to regulate the content of emulsifier in the final emulsion and to thus adjust the stability of the emulsion to the reactivity of the aggregate.

A brief description of the figures is as follows:

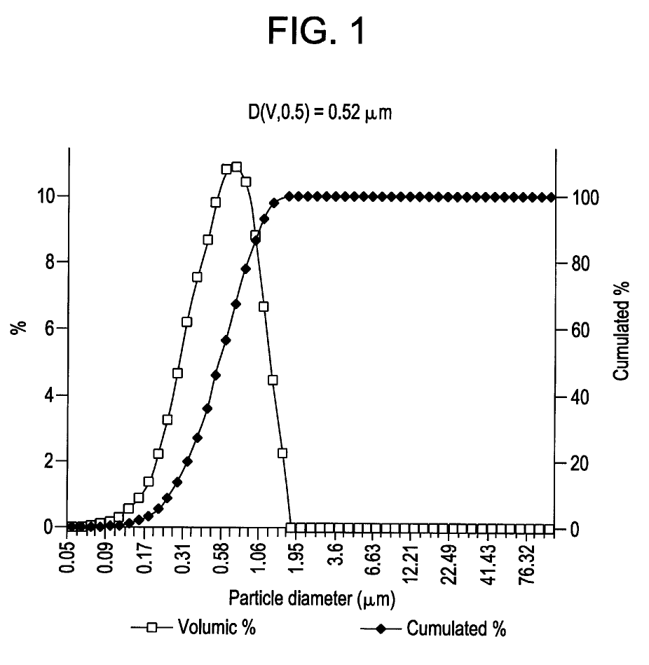

FIG. 1 illustrates the particle size distribution of the emulsion manufactured using Protocol B of the Examples.

FIG. 2 illustrates a roll compactor having utility in Protocol C, 2nd stage.

The mixes with a high surface cohesion manufactured according to the present invention can thus be advantageously manufactured using a mixture in specific proportions of cationic bituminous emulsions, one emulsion of which exhibits particles with a median diameter of less than or equal to 0.6 μm (preferably less than or equal to 0.55 μm and more preferably still less than or equal to 0.5 μm) and the other emulsion of which has a content of emulsifier adjusted in order to obtain a final content of emulsifier in the mixture suited to the aggregate to be coated. However, it is obvious to a person skilled in the art that the advantage also exists with mixtures of anionic or nonionic emulsions, indeed even anionic/nonionic or cationic/nonionic mixtures.

The bituminous binders employed in this invention can be chosen from the bituminous binders normally employed in bituminous emulsions for gravel and cold mixes for surfacing courses, their penetrability generally being between 70/100 and 500.

The emulsions can be prepared with one or more binders; in the latter case, the various binders can be mixed under hot conditions before the emulsification or the two emulsions (or more) can be prepared each comprising a different binder.

The types of cold mixes according to the invention are obtained by kneading the aggregates, moistened with added water, and the bituminous emulsion according to known techniques and using known equipment. The stages of coating, breaking the emulsion, possible transportation, discharging and applying are carried out according to the usual process of roadbuilding and thus do not require modification to the equipment or modifications to the settings. The target to be obtained is, in these cases, an improved surface cohesion once all the stages preceding the opening to traffic have been carried out.

A subject-matter of the present invention is thus first a bituminous roadbuilding material obtained by impregnating, coating or contacting an aggregate, a recycling material, a coated aggregate or a mixture of these products with a bituminous emulsion (E), characterized in that the bitumen particles of the bituminous emulsion (E) used for the impregnating, coating or contacting comprise a fraction (F) representing 10 to 40% of the bitumen particles and having a median diameter of less than or equal to 0.6 μm, preferably of between 0.1 μm and 0.6 μm, the remainder of the bitumen particles of the emulsion having a median diameter of greater than or equal to 1 μm, preferably of between 1 and 20 μm.

The term “coating aggregate” is understood to mean any material originating from the destruction of pavements of mixes and the term “recycling material” is understood to mean any type of material resulting from the recovery of industrial waste capable of being recycled in the manufacture of roadbuilding mixes (demolition materials, clinker, slag from the iron and steel industry, tyres, and the like). Preferably, according to the present invention, the material is composed of cold mixes or of emulsion-stabilized gravel.

The median diameters are, according to the invention, measured by laser particle sizing. The term “median diameter” is understood to mean the value of the diameter of the dispersed bitumen particles which exactly divides the population recorded into two halves of equal volume.

The fraction (F) of bitumen particles has in particular a median diameter of less than or equal to 0.55 μm, in particular less than or equal to 0.5 μm. It can in particular represent 20 to 30% of the bitumen particles.

The remainder of the bitumen particles of the emulsion has, for example, a median diameter of 2 to 10 μm.

In accordance with a specific embodiment of the material according to the present invention, the bituminous emulsion (E) is formed by the mixing of at least two emulsions (A) and (B), at least one (A) of which is composed of bitumen particles with a median diameter of less than or equal to 0.6 μm, in particular less than or equal to 0.55 μm, which particles constitute the abovementioned fraction (F) of the bitumen particles, the other emulsion or emulsions (B) being composed of particles with a median diameter of greater than or equal to 1 μm, the particles of the emulsion or emulsions (B) having in particular a median diameter of 2 to 10 μm.

The emulsion or emulsions (A) composed of bitumen particles with a median diameter of less than or equal to 0.6 μm, in particular less than or equal to 0.55 μm, more particularly less than or equal to 0.5 μm, can represent from 10 to 40% by weight, in particular from 20 to 30% by weight, of the mixture.

An emulsion composed of bitumen particles with a median diameter of less than or equal to 0.6 μm has advantageously been prepared by the process comprising the following stages:
(a) the surfactant or surfactants, optionally in the presence of at least one acid in the case of a cationic emulsion or in the presence of at least one base in the case of an anionic emulsion, are formulated in the form of a concentrated aqueous solution, in particular at more than 30% by weight;
(b) heated bitumen, at a temperature of between 50 and 120° C., is gradually added with a controlled flow rate to the concentrated solution of surfactant(s), which is kept stirred, until the bitumen content of the emulsion at the end of this emulsification stage is greater than or equal to 90% by weight; then
(c) the bitumen content of the emulsion is lowered down to a content preferably of between 60% and 80% by weight by diluting, with stirring, with water having a temperature of between 20 and 90° C. and preferably between 40 and 80° C.

The stirring system of stages (b) and (c) can be a turbine stirrer, a scraping anchor stirrer, a propeller stirrer or, preferably, a whip stirrer, the stirring speed of which is greater than 50 rpm, or any other system equivalent in terms of mixing capability.

The emulsion or emulsions other than that/those composed of bitumen particles with a median diameter of less than or equal to 0.6 μm, in particular less than or equal to 0.55 μm, preferably less than or equal to 0.5 μm, can have a content of surfactant regulated in order to adjust the stability of the mixture of emulsions to the aggregate to be coated. Such other emulsions are conventional emulsions in the roadbuilding industry, having a median diameter, for example, of the order of 2 to 10 μm.

Generally, the roadbuilding industry makes a distinction between different types of emulsion according to their stability with regard to the aggregates. This stability is suited to the application and use is made of “rapid breaking” emulsions for spreading, “medium breaking” or “slow breaking” emulsions for coating and “slow breaking” or super-stabilized emulsions for impregnating. For cationic emulsions, further details may be found with regard to this classification in Standard NF EN 13808. In the case of coating, which is of particular interest to us in the context of the present invention, the emulsion has to be sufficiently stable in the presence of the aggregate in order to be distributed over the entire inorganic surface but not too stable so that destabilization takes place before halting the kneading, in order to avoid the formation of a continuous film of binder in the mix during storage, which subsequently presents major problems of workability in the downstream stages of the process. The kneading time is a variable characteristic as it depends on the coating plant used. The reactivity of the aggregate with regard to an emulsion is a variable which depends on the inorganic nature of the aggregate and on its state of division. It is thus necessary to adjust the stability of the emulsion to the type of aggregate used and to the coating equipment in order to prevent coating from being deficient, in the case of excessively low stability, or to prevent a lack of workability of the mix on discharging and applying, in the case of excessively high stability. This adjusting of the stability of the emulsion is generally carried out by the choice of the surfactant and its dosage in the emulsion. This adjusting is very easy for standard industrial bituminous emulsions with a median diameter of between 2 and 10 μm as the equipment used to manufacture them, namely generally a colloid mill or pressurized static mixer, makes it possible to operate with a wide dosage range of surfactant and in particular with contents as low as 0.15%.

In the case of emulsions composed of bitumen particles with a median diameter of less than or equal to 0.6 μm, the manufacturing process may impose an emulsifier nature and an emulsifier content which result in an emulsion with an excessively high stability with respect to the aggregate and the coating equipment used. The mixing with a standard emulsion, the emulsifier content of which can be lowered at will, then makes it possible to regulate the overall content of emulsifier in order to adjust the stability of the emulsion according to the invention to the aggregate and to the coating equipment used while retaining the advantages in cohesion of an emulsion, the particles of which have a median diameter of less than or equal to 0.6 μm.

The emulsion (E) or, in the case of the abovementioned mixture according to the preferred embodiment of the present invention, each emulsion can be prepared with one or more bituminous binders; in the latter case, the various binders can be mixed under hot conditions before emulsification. In the case of the mixture of two or more emulsions, each of these, comprising at least one binder, can be prepared and they are subsequently mixed in order to give a “mixed” emulsion which will be contacted with the aggregates or the like in order to prepare the material.

The bituminous emulsion or emulsions used for the coating, impregnating or contacting comprises or comprise at least one anionic surfactant and, if appropriate, at least one base, or at least one cationic surfactant and, if appropriate, at least one acid, in particular a cationic surfactant and, if appropriate, at least one acid.

The surfactant or surfactants is or are chosen in particular from alkyl(ene)polyamines, oxyalkylenated alkyl(ene)polyamines, quaternary alkyl(ene)ammonium salts, alkyl(ene)amidoamines and their alkyl(ene)imidazoline cyclization derivatives, with an alkyl chain comprising between 8 and 22 carbon atoms, oxyalkylenated alkyl(ene)polyamines and more particularly oxypropylenated tallow dipropylenetriamine (amines, N-tallow-[[3-[(3-aminopropyl)amino]propyl]-imino]-1,1′-bis(propan-2-ol), RN=97592-79-5), the latter being well represented industrially by Polyramo SL, sold by Ceca S.A.

The bituminous emulsion or emulsions used for the coating, impregnating and contacting can also comprise at least one nonionic cosurfactant.

Use may also be made of mixtures of cationic surfactants or of cationic surfactants and of nonionic cosurfactants, the limitation being related to the maximum acceptable concentration in solution to prevent gelling. It would not be departing from the scope of the invention to employ any technique known to a person skilled in the art which makes it possible to avoid the formation of gels in concentrated solutions of surfactants, such as the use of cosolvents and/or of hydrotropes.

As indicated above, it is preferable to add a certain amount of acid(s), generally chosen from HCl or H₃PO₄, to the aqueous phases of cationic surfactant(s), which are preferred surfactants.

The bitumens or bituminous binders can be chosen from the bituminous binders normally employed in bituminous emulsions for emulsion-stabilized gravel and/or cold mixes for surfacing courses; their penetrability is generally between 70/100 and 500. Their chemical nature depends on the crude or crudes from which they originate. A distinction is made between paraffinic bitumens, preferred by the Applicant Company, and naphthenic bitumens.

The cold mixes and emulsion-stabilized gravel according to the invention can be obtained by kneading the aggregates, moistened with added water, and the bituminous emulsion defined above according to techniques and using equipment which are known and commonly used in the roadbuilding industry. The stages of coating, breaking the emulsion, possible transportation, discharging and applying are carried out according to the usual process of roadbuilding and exhibit the advantage of not requiring modifications to equipment or modifications to the settings, while showing an improved cohesion once all the stages preceding the opening to traffic have been carried out.

The present invention also relates to the use of a material as defined above for forming a road pavement or a roadway with high resistance to traffic in the first 24 hours (at an early age). This is because the invention is particularly advantageous for roadways with heavy traffic, insofar as it makes it possible to obtain road pavements having a cohesion sufficient to stabilize the structure before reopening to traffic without it being necessary to wait several days.

The present invention also relates to a road pavement obtained by compacting a material as defined above.

Finally, the present invention relates to a bituminous emulsion capable of being obtained by mixing:
at least one bituminous emulsion composed of particles with a median diameter of less than or equal to 0.6 μm (Emulsion A); and
at least one bituminous emulsion composed of particles with a median diameter of greater than or equal to 1 μm (Emulsion B),
   the bitumen particles with a median diameter of less than or equal to 0.6 μm of the emulsion or emulsions (A) representing 10 to 40% of the total bitumen particles of the emulsions (A) and (B).

The bitumen particles of the emulsion or emulsions (A) can in particular have a median diameter of less than or equal to 0.55 μm, in particular less than 0.5 μm. The bitumen particles with a median diameter of less than or equal to 0.6 μm of the emulsion or emulsions (A) can in particular represent from 20 to 30% of the total bitumen particles of the emulsions (A) and (B).

The bitumen particles of the emulsion or emulsions (B) can have a median diameter from 2 to 10 μm.

Furthermore, the emulsion or emulsions (A) can represent from 10 to 40% by weight, in particular from 20 to 30% by weight, of the mixture.

The following Examples illustrate the present invention without, however, limiting the scope thereof. In these examples, the percentages are by weight, unless otherwise indicated.

Protocol A: Preparation of a Concentrated Solution of Surfactant for the Purpose of the Manufacture of an Emulsion with a Median Diameter of 0.5 μm

A beaker is placed in a water bath and both a stirring propeller and a pH electrode with temperature compensation are fitted therein. The amount of water necessary to manufacture the desired soap is placed in the beaker. Stirring is begun and heating is begun of the water present in the beaker to T=50° C.

The chosen surfactant is heated to T=60° C. on a regulated heating plate.

When the water and the surfactant have reached the specified temperatures, the addition is begun of the surfactant (in this instance Polyram® SL, sold by Ceca) to the water using a dropper, so as to bring the pH to approximately 5-6. Acidification is carried out with 37% HCl (at ambient temperature) until a pH of between 1 and 2 is obtained, so as to dissolve all the surfactant added. Further surfactant is added until a pH of between 5 and 6 approximately is obtained, then acidification is again carried out until a pH of between 1 and 2 is obtained, and so on, until a small amount of gel which does not dissolve in the solution is obtained (which corresponds to a concentration of surfactant in the vicinity of 23% for Polyram® SL). From this point, the mixture is acidified until a pH of 0.6 is obtained. The addition of the surfactant is continued at the rate of approximately 1 g every 5 minutes, on each occasion adding the amount of acid necessary to bring the pH back to approximately 0.5-0.6. It was possible, by weighing the combined beaker+propeller, to monitor the concentration of surfactant occurring during the manufacture. Thus, it is possible to proceed as far as a surfactant concentration in the vicinity of 28%.

In order to range up to 31% (which is the concentration necessary in order to obtain the median diameter targeted here), the water is allowed to gently evaporate while adding acid when a small amount of gel is seen forming.

Protocol B: Preparation and Analysis of an Emulsion with a Median Diameter of Less than 0.6 μm

167 g of emulsion comprising 60% of bitumen with a median diameter of 0.5 μm are prepared according to the following procedure:

100 g of 70/100 Total Donges bitumen are heated on a regulated heating plate to a temperature of 108° C.

60 g of deionized H₂O are heated to T=60° C. on a regulated heating plate.

7 g of concentrated soap prepared as indicated in Protocol A (T=ambient) are placed at the bottom of a 600 cm³ beaker (tall form: height of 12 cm and diameter of 8.5 cm). The stirring system, which rests on the bottom of the beaker (metal kitchen whip with a diameter of 6 cm over a height of 13 cm, mounted on a stirrer shaft, and Leroy-Somer stirrer motor with a power of 245 W, torque of 0.8 N·m), its speed being preset at 600 rpm, is put in place.

After the deionized water and the bitumen have reached the temperature for manufacturing the emulsion, the whip is then switched on (V=600 rpm) and the hot bitumen is gradually run onto the concentrated soap for 1 min to 1 min 15 sec (not less as a faster flow rate generates an inverse emulsion); when all the bitumen has been run in, stirring is continued for 15 to 20 seconds before running the deionized water onto the concentrated bitumen emulsion over approximately 5 seconds; the whip is allowed to rotate for a further 1 minute 30 seconds approximately in order to homogenize the emulsion.

The particle size analysis of the emulsion is carried out using a Mastersizer S laser particle sizer from Malvern Instruments. The coefficients taken for the calculations are 1.62 and 0.0055 for the bitumen and 1.33 for the water. The values given in the text as median diameter of the emulsion correspond to the value D (v, 0.5) given by the device, that is to say the maximum value of the diameter of the dispersed bitumen particles representing 50% of the volume of the emulsion. In the example given here, it is 0.52 μm.

The particle size distribution of the emulsion manufactured is given in FIG. 1 of the appended drawing.

### Protocol C: Manufacture and Measurement of Surface Cohesion of the Emulsion Mixes

The measurement of surface cohesion of the mixes is carried out using a ring shear device, model RST 01.PC (designed by Mr Dietmar Schulze, Germany), which imposes a deformation until breaking on a compacted mix placed in an annular cell surmounted by a cover connected to two force sensors.

Measuring cohesion for a mix necessarily involves the stages described below:

1st Stage: Manufacture of the Mix and Insertion of the Mix into the Annular Measurement Cell of the Ring Shear Device

In order to carry out a cohesion measurement, it is necessary to manufacture approximately 1350 g of mix in the following way:
1200 g of aggregate with the required particle size composition are weighed out in a stainless steel bowl;
the percentage of water required with respect to the aggregate is added;
the entire contents of the bowl are mixed for a few seconds with a spatula in order to properly distribute the water over all the aggregate;
the amount of bitumen emulsion required is rapidly added to the aggregate;
mixing is carried out with a spatula until the emulsion on the aggregate breaks;
the lower part of the annular cell of the measurement device is filled with the mix, the latter being given the best possible distribution.

The annular cell is made up of two components: a lower part provided with fins, which comprises the mix, and a cover, itself also provided with fins. The characteristics of the lower part of the annular cell used are as follows: small diameter=100 mm, large diameter=200 mm, depth=40 mm, and 20 fins with a width of 44 mm and a height of 5 mm which are screwed onto its base. The characteristics of the cover of the annular cell used are as follows: small diameter=105 mm, large diameter=195 mm, and 20 fins with a width of 44 mm and a height of 5 mm which are screwed underneath.

After subsequently waiting for 45 minutes after the breaking of the emulsion on the aggregate, the mix is compacted inside the measurement cell.

### 2nd Stage: Compacting of the Mix Inside the Measurement Cell, Applying the Cover in Order to Produce the Impression of the Fins in the Mix Before the Drying Thereof, and Removing the Cover for the Drying

The mix inside the measurement cell is compacted using a roll compactor, as represented in FIG. 2 of the appended drawing, especially designed to make it possible to produce a rearrangement in the mix in order to simulate as best as possible what happens on the ground during this phase.

This roll compactor is composed of an arm which can rotate about its central axis by virtue of an electric motor. This arm is equipped with a stainless steel roll at each end and is provided with a support on which several weights, each weighing 10 kg, can be placed so as to be able to adjust the compacting to its specific requirements.

The width of the rolls in contact with the mix is equal to 45 mm. The support for the arm can accept a load of up to 70 kg. The electric motor which rotates the arm of the compactor has a power equal to 1400 W; it is equipped both with a device for varying the frequency and with a reducer which reduces the rotational speed of the motor by a factor of 5, which corresponds to a maximum rotational speed of 300 rpm.

The following procedure is used to compact a mix:
the arm with its two rolls is placed on the mix;
the support for the arm is loaded with the desired weight; and
the arm is rotated about its central axis at the desired speed by varying the supply frequency of the electric drive motor.

The compacting conditions used for the present tests are as follows:
1 minute with a load of 0 kg on the support for the arm at V=1 km/h at the centre of the ring;
1 minute with a load of 10 kg on the support for the arm at V=1 km/h at the centre of the ring;
1 minute with a load of 20 kg on the support for the arm at V=1 km/h at the centre of the ring;
1 minute with a load of 30 kg on the support for the arm at V=1 km/h at the centre of the ring;
1 minute with a load of 40 kg on the support for the arm at V=1 km/h at the centre of the ring;
1 minute with a load of 50 kg on the support for the arm at V=1 km/h at the centre of the ring.

The load is gradually increased so as not to excessively push the two rolls into the mix before starting to rotate the arm. These compacting conditions make it possible to obtain degrees of compactness of the order of 80%, measured by differences in height in the measurement cell.

When the mix is compacted, the cover of the measurement cell is placed on its surface and the fins are pushed in by 5 mm using a load rig of the Instron trade name, model 1186, equipped with a 200 kN force sensor, in order to produce the impression of the fins of the cover at the surface of the mix. As soon as the cover has finished being pushed in, it is removed in order to allow the mix to dry in the open air for the desired time.

### 3rd Stage: Measurement of the Surface Cohesion of the Mixes

when the drying time for the mix, set at 19 hours in the present tests, has passed, the cover is put back in place at the surface of the mix, care being taken to place the fins back in their impressions;
the annular cell, surmounted by its cover, is placed on the cohesion measurement device, model RSTC 01.PC, equipped with two force sensors each of 50 kg, designed by Mr Dietmar Schulze, Germany;
the cover is connected to the two force sensors of the device;
the measurement of cohesion of the mix is set under way by imposing a pressure of 0.2 bar on the cover and by imposing a circular deformation by rotating the annular cell at V=2 deg/min with respect to the cover, which remains stationary between the two force sensors, so as to bring about breaking of the mix and to go slightly beyond this;
at the same time, the device records the force of resistance to deformation of the mix and the time, which makes it possible to obtain Force=f(time) graphs and to determine the force necessary for the breaking of the mix.

The value selected as cohesion value is the maximum force observed before breaking, from which is subtracted the force generated by the friction of the aggregates (a force which becomes constant as a function of time after breaking).

### Protocol D: Manufacture and Measurement of Core Cohesion of the Emulsion Mixes

In order to carry out a measurement of core cohesion, it is necessary to manufacture approximately 900 g of mix in the following way:
800 g of aggregate with the required particle size composition are weighed out in a stainless steel bowl;
the percentage of water required with respect to the aggregate is added;
the entire contents of the bowl are mixed for a few seconds with a spatula in order to properly distribute the water over all the aggregate;
the amount of bitumen emulsion required is rapidly added to the aggregate;
mixing is carried out with a spatula until the emulsion on the aggregate breaks.

The mixes thus manufactured are stored in the bowl for 1 hour under ambient laboratory conditions, taken up with a spatula and swollen by hand, if necessary, and then placed in a Gyratory Shear Compactor “GSC” mould (cylindrical mould with a diameter of 100 mm and a height of 25 cm).

The mixes are compacted using the Gyratory Shear Compactor (Invelop Oy model ICT-100RB) under a pressure of 0.6 MPa, with an angle of gyration of 1°, for 120 revolutions or gyrations.

The test specimens thus manufactured are stored for 1 h under ambient laboratory conditions and then fractured. The test specimens are fractured by diametral compression at a rate of 200 mm/min using a press (Instron, model 4482). The core cohesion is defined as being the maximum value of the force of reaction of the test specimen to the jaw during the deformation up to fracturing.

### EXAMPLES

The improvement in the performances of the roadbuilding products according to the present invention was assessed by comparison between formulations of mixes according to the prior art (coating with emulsions manufactured to 100% with a colloid mill) and formulations according to the present invention. In order for the comparison to be easier, in the examples which follow, the same cationic emulsifier (a polyamine sold by Ceca under the name Polyram® SL) was used in the different formulations. A change in emulsifier would not in any way depart from the scope of the present invention.

### Example 1

### Impact of the Composition of the Mixture of Emulsions on the Cohesion Properties of the Mix

Five different emulsions were prepared by mixing the following two emulsions:
emulsion with a median diameter of 0.52 μm, manufactured according to the above Protocol B;
emulsion manufactured using an Emulbitume laboratory set equipped with an Atomix C colloid mill and with the composition: 60% of Total Donges 70/100 bitumen, 14 kg/t of Polyram SL and hydrochloric acid for an aqueous phase pH adjusted to 2. This emulsion has a median diameter of 4.5 μm.

In this example, the amount of emulsifier of the standard emulsion was deliberately set at the same level as that of the emulsion with a controlled median diameter in order not to modify the content of emulsifier in the various mixtures, which made it possible to isolate the impact of the particle size distribution on the performances of the mix.

The characteristics of these emulsions are given in the following Table 1.

TABLE 1
Characteristics of the emulsions which were
used in the example

| | Content of emulsion | Content of |
|---|---|---|
| | with a median | “standard” |
| Emulsion | diameter of 0.52 μm | emulsion |
| E1 | 100 | 0 |
| E2 | 75 | 25 |
| E3 | 50 | 50 |
| E4 | 25 | 75 |
| E5 | 0 | 100 |

With each of these emulsions, a cold mix was prepared both according to Protocol C, 1st stage and 2nd stage, and according to Protocol D described above. The aggregates used are siliceous limestone aggregates sold under the name “Abjat” and “Thiviers”, the particle size distribution of which is as follows:
28% aggregate 0/2 “Thiviers”
12% aggregate 0/3 “Abjat”
12% aggregate 2/6 “Abjat”
48% aggregate 4/6 “Abjat”.

The content of filler (particles of aggregates which pass through an 80 μm sieve) is of the order of 7% by weight. The content of added water in the mix is 4 g per 100 g of aggregates. The content of emulsion in the mix is 9.5%.

The surface and core cohesion of the mixes thus manufactured is tested both according to Protocol C, 3rd stage, and Protocol D described above. The results are presented in Table 2.

TABLE 2
Results of measurement of cohesion on the
mixes manufactured with emulsions described in Example 1

| Emulsion used for | Surface cohesion | Core cohesion |
|---|---|---|
| the coating | (kg) | (kN) |
| E1 | 51 | 3 |
| E2 | 50 | 3.1 |
| E3 | 46 | 3.2 |
| E4 | 45 | 4.2 |
| E5 | 31 | 4.3 |

Highly surprisingly, the two properties do not vary in the same direction and phenomena of plateau or of significant change in slope are observed which reveal an optimum in the vicinity of a mixture comprising 75% of standard emulsion and 25% of emulsion with a median diameter of 0.5 μm. Under these conditions, the core cohesion is optimal and the surface cohesion is improved by 50% with respect to a mix produced with a standard emulsion.

### Example 2

### Adjusting of the Stability of the Emulsion with Regard to the Aggregate

Two emulsions comprising 60% of Total Donges 70/100 bitumen are prepared with different dosages of Polyram® SL according to a conventional industrial method with a colloid mill (laboratory production set of the Emulbitume trade name):
emulsion E6 comprising 4 kg/t of Polyram SL (based on the emulsion) and acidified with HCl for an aqueous phase pH of 2 with a median diameter of 4.8 μm;
emulsion E5 comprising 14 kg/t of Polyram SL (based on the emulsion) and acidified with HCl for an aqueous phase pH of 2 with a median diameter of 4.5 μm.

These two emulsions are each mixed with the emulsion E1 with a median diameter of 0.52 μm manufactured according to the Protocol B described above, in the 75%/25% ratio determined as optimum in Example 1.

A cold mix is manufactured with each of these mixtures of emulsions in comparison with the emulsions alone on the mixture of aggregate composed of siliceous limestone aggregates sold under the name “Abjat” and “Thiviers”, the particle size distribution of which is as follows:
28% aggregate 0/2 “Thiviers”
12% aggregate 0/3 “Abjat”
12% aggregate 2/6 “Abjat”
48% aggregate 4/6 “Abjat”.

For each coating, the “breaking time” of the emulsion and the core and surface cohesions are measured as described above.

The breaking time of the emulsion is evaluated on 500 g of aggregates in a stainless steel bowl: the aggregates are weighed out and 4% of water is added, then the mixture of water and aggregate is homogenized with a metal spatula for about 10 seconds, then 9.5% of emulsion is subsequently added and kneading is carried out with the spatula until breaking occurs. The breaking time is defined here as the time at the end of which liquid emulsion is no longer observed on the walls of the bowl during the kneading. For the roadbuilding applications targeted in the present invention, the search is rather for breaking times of the order of 15 to 25 seconds. With shorter breaking times, the coating will be poor at the kneader outlet; with longer breaking times, there is a serious risk of solidification on storage.

The results are summarized in Table 3.

TABLE 3
Results of coating and of cohesion
measurement on mixes produced with emulsions
manufactured differently and with different
compositions

| | Breaking | | Surface | Core |
|---|---|---|---|---|
| | time | Coating | cohesion | cohesion |
| Emulsion | (s) | observation | (kg) | (kN) |
| E1 | 120 | Well coated | 51 | 3 |
| | | greasy | | |
| | | appearance | | |
| E5 | 65 | Well coated | 31 | 4.3 |
| | | dry appearance | | |
| E6 | 10 | Dry appearance | 27 | 3.5 |
| | | very incomplete | | |
| | | coating | | |
| 75% E5/25% E1 | 80 | Dry appearance | 45 | 4.2 |
| | | good coating | | |
| 75% E6/25% E1 | 20 | Dry appearance | 44 | 4.2 |
| | | good coating | | |

The emulsion E1 with a median diameter of 0.52 μm alone exhibits serious risks of solidification on storage because of the excessively long breaking time related to its high dosage of emulsifier, which is confirmed by the excessively long result obtained with the standard emulsion E5 comprising 14 kg/t of Polyram SL. The standard emulsion E6, which comprises a very small dose of emulsifier, does not make satisfactory coating possible but a mixture of E1 and E6 gives exactly the expected breaking time with an excellent coating quality.

By virtue of the discovery which is a subject-matter of this invention, this mixture of emulsions results not only in a core cohesion of the best level observed for this emulsion mix and an early-age surface cohesion improved by 50% with respect to a mix produced with a standard emulsion but also in a breaking time of emulsion suited to the aggregate and in accordance with the requirements of the targeted roadbuilding applications in order to avoid problems of workability.

1. Bituminous roadbuilding material obtained by impregnating, coating or contacting an aggregate, a recycling material, a coated aggregate or a mixture of these products with a bituminous emulsion (E), characterized in that the bitumen particles of the bituminous emulsion (E) used for the impregnating, coating or contacting comprise a fraction (F) representing 10 to 40% of the bitumen particles and having a median diameter of less than or equal to 0.6 μm, the remainder of the bitumen particles of the emulsion having a median diameter of greater than or equal to 1 μm.

2. Material according to claim 1, wherein it is composed of cold mixes or of emulsion-stabilized gravel.

3. Material according to claim 1, wherein fraction (F) of bitumen particles has a median diameter of less than or equal to 0.55 μm.

4. Material according to claim 1, wherein fraction (F) represents 20 to 30% of the bitumen particles.

5. Material according to claim 1, characterized in that the remainder of the bitumen particles of the emulsion has a median diameter of 2 to 10 μm.

6. Material according to claim 1, characterized in that the bituminous emulsion (E) is formed by the mixing of at least two emulsions (A) and (B), at least one emulsion (A) of which is composed of bitumen particles with a median diameter of less than or equal to 0.6 μm, the other emulsion (B) being composed of particles with a median diameter of greater than or equal to 1 μm, the particles of the emulsion (B) having in particular a median diameter of 2 to 10 μm.

7. Material according to claim 6, characterized in that the emulsion (A) composed of bitumen particles with a median diameter of less than or equal to 0.6 μm, represent(s) from 10 to 40% by weight of the mixture.

8. (canceled)

9. Material according to claim 6, characterized in that the emulsion other than that composed of bitumen particles with a median diameter of less than or equal to 0.6 μm, has a content of surfactant regulated in order to adjust the stability of the mixture of emulsions to the aggregate to be coated.

10. Material according to claim 1, characterized in that the bituminous emulsion used for the coating, impregnating or contacting comprises at least one anionic surfactant and, optionally at least one base, or at least one cationic surfactant and, optionally at least one acid.

11. Material according to claim 10, characterized in that the cationic surfactant is chosen from alkyl(ene)polyamines, oxyalkylenated alkyl(ene)polyamines, quaternary alkyl(ene)ammonium salts, alkyl(ene)amidoamines and their alkyl(ene)imidazoline cyclization derivatives, with an alkyl chain comprising between 8 and 22 carbon atoms, or oxyalkylenated alkyl(ene)polyamines.

12. Material according to claim 1, characterized in that the bituminous emulsion used for the coating, impregnating and compacting comprise at least one nonionic cosurfactant.

13. Use of a material as defined in claim 1, for forming a road pavement or a roadway with high resistance to traffic in the first 24 hours.

14. Road pavement obtained by compacting a material as defined in claim 1.

15. Bituminous emulsion obtained by mixing:
at least one bituminous emulsion composed of particles with a median diameter of less than or equal to 0.6 μm (Emulsion A); and
at least one bituminous emulsion composed of particles with a median diameter of greater than or equal to 1 μm (Emulsion B),
wherein the bitumen particles with a median diameter of less than or equal to 0.6 μm of the emulsion or emulsions (Emulsion A) represent 10 to 400 of the Bituminous emulsion.

16. Bituminous emulsion according to claim 15, characterized in that the bitumen particles of Emulsion A have a median diameter of less than or equal to 0.55 μm.

17. Bituminous emulsion according to claim 15, characterized in that the bitumen particles with a median diameter of less than or equal to 0.6 μm of Emulsion A represent from 20 to 30% of the total bitumen particles of the Bituminous emulsion.

18. Bituminous emulsion according to claim 15, characterized in that the bitumen particles of the Emulsion B have a median diameter from 2 to 10 μm.

19. Bituminous emulsion according to claim 15, characterized in that the Emulsion A represent from 10 to 40% by weight, of the mixture.

20. Bituminous roadbuilding material obtained by impregnating, coating or contacting an aggregate, a recycling material, a coated aggregate or a mixture of these products with a bituminous emulsion (E), characterized in that the bitumen particles of the bituminous emulsion (E) used for the impregnating, coating or contacting comprise a fraction (F) representing 10 to 40% of the bitumen particles and having a median diameter between 0.1 μm and 0.6 μm, the remainder of the bitumen particles of the emulsion having a median diameter of between 1 and 20 μm.

21. Material according to claim 6, characterized in that the emulsion (A) composed of bitumen particles with a median diameter of less than or equal to 0.6 μm, represents from 20 to 30% by weight of the mixture.

22. Material according to claim 6, characterized in that an emulsion composed of bitumen particles with a median diameter of less than or equal to 0.6 μm has been prepared by the process comprising the following steps:
(a) forming a concentrated aqueous cationic or anionic emulsion of surfactants, optionally in the presence of at least one acid in the case of a cationic emulsion or in the presence of at least one base in the case of an anionic emulsion;
(b) adding heated bitumen, at a temperature of between 50 and 120° C. with a controlled flow rate to the concentrated aqueous cationic or anionic emulsion, with stirring, until the bitumen content of the concentrated aqueous cationic or anionic emulsion is greater than or equal to 90% by weight; and
(c) diluting the bitumen content of the concentrated aqueous cationic or anionic emulsion to between 60% and 80% by weight bitumen by adding, with stirring, water having a temperature of between 20 and 90° C.
